(19) United States
(12) Patent Application Publication
(10) Pub. No.: US 2015/0102769 A1
(43) Pub. Date: Apr. 16, 2015

(54) WIRELESS CHARGING OF TOOLS USING A TOOLBOX TRANSMITTER

(71) Applicant: DvineWave Inc., San Ramon, CA (US)

(72) Inventors: Michael A. Leabman, San Ramon, CA (US); Gregory Scott Brewer, Livermore, CA (US)

(73) Assignee: DvineWave Inc., San Ramon, CA (US)

(21) Appl. No.: 14/051,128

(22) Filed: Oct. 10, 2013

(51) Int. Cl. H04B 5/00; H02J 7/02

(52) U.S. Cl. CPC H04B 5/0037; H02J 7/025
USPC 320/108; 307/104; 320/137

(57) ABSTRACT

Configurations and methods of wireless power transmission for cordless power tools are disclosed. Wireless power transmission for charging one or more cordless power tools may include a toolbox with an embedded transmitter capable of emitting RF waves for the generation of pockets of energy; a battery attached or embedded in the toolbox to supply power to the transmitter; a cable that may connect toolbox's battery to a suitable external power source for charging; and one or more cordless power tools which may include rechargeable batteries and receivers that may utilize pockets of energy for wireless charging or powering. When the battery in the toolbox is charged to suitable levels, the toolbox can be disconnected from the external power source and carried to an area or location where one or more cordless power tools may receive wireless charging.

### CROSS-REFERENCES TO RELATED APPLICATIONS

The present disclosure is related to U.S. Non-Provisional patent application Ser. No. 13/891,430 filed May 10, 2013, entitled “Methodology For Pocket-forming”; Ser. No. 13/925,469 filed Jun. 24, 2013, entitled “Methodology for Multiple Pocket-Forming”; Ser. No. 13/946,082 filed Jul. 19, 2013, entitled “Method for 3 Dimensional Pocket-forming”; Ser. No. 13/891,399 filed May 10, 2013, entitled “Receivers for Wireless Power Transmission” and Ser. No. 13/891,445 filed May 10, 2013, entitled “Transmitters For Wireless Power Transmission”, the entire contents of which are incorporated herein by these references.

### FIELD OF INVENTION

The present disclosure relates in general to wireless power transmission, and more specifically to configurations and methods of wireless power transmission using a toolbox and one or more cordless power tools.

### BACKGROUND OF THE INVENTION

Power tools such as drills, screwdrivers, circular saws, milers, grinders, and the like, are proven to be very useful for domestic and industrial applications alike. These power tools are usually offered in corded and cordless versions. In particular, cordless power tools may be battery powered, which allows them to be portable and easy to store. In addition, cordless power tools may be particularly beneficial when working in unfinished construction sites where there may be no electrical power source available. However, unlike corded, cordless power tools may exhibit limited operating time and may rely on a suitable charged battery to operate efficiently.

What are needed are a device or system and a suitable method that may allow transporting and storing one or more cordless power tools while supplying suitable electrical charge for continuous or extended operation.

### SUMMARY OF THE INVENTION

Configurations and methods of wireless power transmission for cordless power tools are disclosed, Wireless power transmission for charging one or more cordless power tools may include a toolbox with an embedded transmitter capable of emitting RF waves for the generation of pockets of energy; a battery attached or embedded in the toolbox to supply power to the transmitter; a cable that may connect toolbox's battery to a suitable external power source for charging; and one or more cordless power tools which may include rechargeable batteries and receivers that may utilize pockets of energy for wireless charging or powering.

According to an embodiment, a toolbox may he used to carry and store one or more cordless power tools and related components, materials, or accessories. The disclosed toolbox may include a transmitter utilized for pocket-forming, where this transmitter may include two or more antenna elements, a RF integrated circuit, a communications module, and a microcontroller. The toolbox may also include a battery for powering the transmitter. A cable may be used to connect the toolbox to an external power source, such as a 120/220 AC volts outlet, to provide suitable charge to the battery. In operation, the transmitter embedded in the toolbox may generate and direct RF waves towards one or more receivers attached or embedded in one or more cordless power to wirelessly charge or at least extend the operation of the batteries incorporated in the cordless power tools. The receiver attached or embedded in the cordless power tools may include at least one antenna element, a rectifier, a converter, and a communications component. When the battery in toolbox is charged to a suitable level, toolbox may be disconnected from the AC outlet, and subsequently carried and positioned in a desired working area where one or more cordless power tools may require wireless charging.

In another embodiment, the toolbox with the embedded transmitter may be used within or outside a vehicle, where this toolbox can be connected to an external power source, in this case the vehicle's battery, for charging the battery incorporated in the toolbox. Transmitter in the toolbox may generate and direct RF waves towards one or more receivers attached or embedded in one or more cordless power tools to wirelessly charge or at least extend the operational period of the batteries incorporated in the cordless power tools. When the battery in toolbox is charged to a suitable level, toolbox may be disconnected from the car lighter socket, and subsequently carried and positioned in a desired working area where one or more cordless power tools may require wireless charging.

Yet in another embodiment, the transmitter may be configured in a vehicle's doors or windows, in which case, transmitter may be connected directly to the car lighter socket and may include a higher number of antenna elements which may allow to increase the power and reach of wireless charging for one or more cordless power tools.

In a further embodiment, a method for using the toolbox as a portable wireless charging device may include a charge level check for the battery incorporated in the toolbox, followed by connecting the toolbox to a suitable external power supply if necessary. If battery in toolbox is charged to a suitable level, communication module in the transmitter may identify one or more cordless power tools that may require wireless charging, Transmitter may subsequently generate and direct RF waves towards the identified power tools for charging or at least extending their batteries' operational period.

The disclosed configurations and methods of wireless power transmission may include a toolbox with an embedded transmitter that may provide efficient and simultaneous wireless charging for one or more cordless power tools. This toolbox may be portable and may employ an incorporated battery to power up the transmitter to wirelessly charge one or more cordless power tools in construction sites where spare batteries or other power sources may be nonexistent or limited, Additional features and advantages can become apparent from the detailed descriptions which follow, taken in conjunction with the accompanying drawings.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a wireless power transmission for one or more cordless power tools using pocket forming,

FIG. 2 shows a component level embodiment of a transmitter which may be used in a wireless power transmission for cordless power tools,

FIG. 3 depicts a component level embodiment of a receiver which may be used in a wireless power transmission for cordless power tools,

FIG. 4 illustrates a configuration of a wireless power transmission which may include a transmitter embedded in a toolbox to wirelessly charge or power one or more cordless power tools.

FIG. 5 shows a configuration of a wireless power transmission where a portable toolbox with an embedded transmitter may be located within or outside a vehicle for wireless charging or powering of one or more cordless power tools.

FIG. 6 depicts a configuration of a wireless power transmission where a transmitter may be configured in one of the doors or windows of a vehicle for wireless charging or powering one or more power tools.

FIG. 7 illustrates a simplified flowchart of a wireless power transmission process which may he implemented for the wireless charging of one or more cordless power tools using a toolbox as a portable device.

### DETAILED DESCRIPTION OF THE DRAWINGS

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### Definitions

As used here, the following terms may have the following definitions:

“Pocket-forming” may refer to generating two or more RE waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device including at least one antenna element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

### DESCRIPTION OF THE DRAWINGS

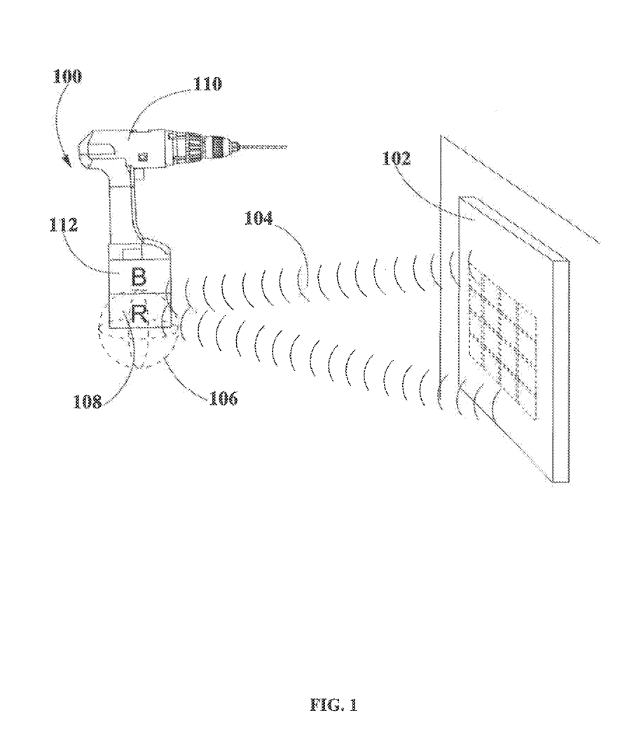

FIG. 1 illustrates a wireless power transmission 100 using pocket-forming. A transmitter 102 may transmit controlled Radio Frequency (RF) waves 104 which may converge in 3-d space. These RF waves 104 may be controlled through phase and/or relative amplitude adjustments to form constructive and destructive interference patterns (pocket-forming). Pockets of energy 106 may be formed at constructive interference patterns and can be 3-dimensional in shape, while null-spaces may be generated at destructive interference patterns. A receiver 108 may then utilize pockets of energy 106 produced by pocket-forming for charging or powering the battery 112 of a cordless power tool 110, for example, a drill (as shown in FIG. 1), a screwdriver, a circular saw, a nailer, a grinder, and the like. In some embodiments, there can be multiple transmitters 102 and/or multiple receivers 108 for powering various cordless power tools 110 at the same time. In other embodiments, adaptive pocket-forming may be used to regulate the power transmitted to cordless power tools 110.

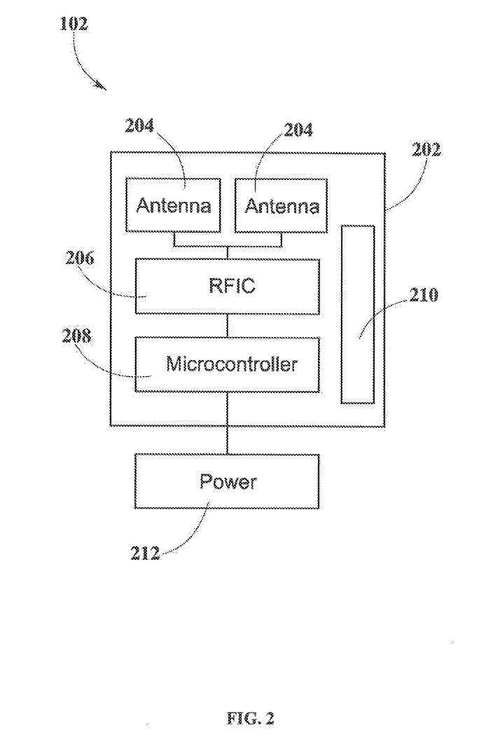

FIG. 2 illustrates a component level embodiment for transmitter 102 which may be used in wireless power transmission 100. Transmitter 102 may include a housing 202, at least two or more antenna elements 204, at least one RE integrated circuit (RFIC) 206, at least one digital signal processor (DSP) or micro-controller 208, and one communications component 210. Housing 202 can be made of any suitable material which may allow for signal or wave transmission and/or reception, for example plastic or hard rubber. Antenna elements 204 may include suitable antenna types for operating in frequency bands such as 900 MHz, 2.5 GHz or 5.8 GHz as these frequency bands conform to Federal Communications Commission (FCC) regulations part 18 (Industrial, Scientific and Medical equipment). Antenna elements 204 may include vertical or horizontal polarization, right hand or left hand polarization, elliptical polarization, or other suitable polarizations as well as suitable polarization combinations. Suitable antenna types may include, for example, patch antennas with heights from about ⅛ inches to about 8 inch and widths from about ⅛ inches to about 6 inch. Other antenna elements 204 types can he used, for example meta-materials, dipole antennas among others.

RFIC 206 may include a proprietary chip for adjusting phases and/or relative magnitudes of RF signals which may serve as inputs for antenna elements 204 for controlling pocket-forming. These RF signals may be produced using a power source 212 and a local oscillator chip (not shown) using a suitable piezoelectric material. Micro-controller 208 may then process information sent by a receiver through communications component 210 for determining optimum times and locations for pocket-forming. Communications component 210 may be based on standard wireless communication protocols which may include Bluetooth, Wi-Fi or ZigBee. In addition, communications component 210 may be used to transfer other information such as an identifier for the device or user, battery level, location or other such information, Other communications component 210 may be possible, including radar, infrared cameras or sound devices for sonic triangulation of the device's position.

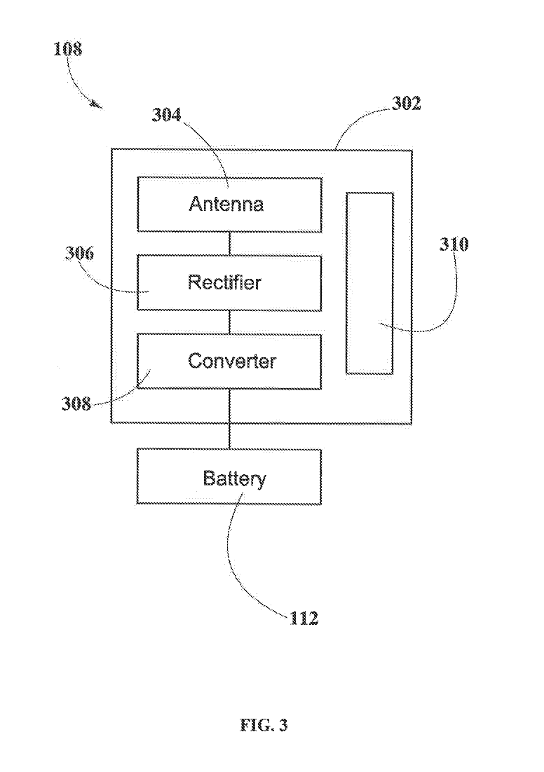

FIG. 3 illustrates a component level embodiment for receiver 108 which can be used for wireless powering or charging a cordless power tool 110 as exemplified in wireless power transmission 100. Receiver 108 may be integrated in cordless power tool 110 and may include a housing 302 where at least one antenna element 304, one rectifier 306, one power converter 308 and a communications component 310 may be included. Housing 302 can be made of any suitable material which may allow for signal or wave transmission and/or reception, for example plastic or hard rubber. Housing 302 may be an external hardware that may be added to different electronic equipment, for example in the form of cases, or can be embedded within electronic equipment as well. Antenna element 304 may include suitable antenna types for operating in frequency bands similar to the bands described for transmitter 102 from FIG. 2. Antenna element 304 may include vertical or horizontal polarization, right hand or left hand polarization, elliptical polarization, or other suitable polarizations as well as suitable polarization combinations. Using multiple polarizations can be beneficial in devices where there may not be a preferred orientation during usage or whose orientation may vary continuously through time, for example cordless power tool 110. On the contrary, for devices with well-defined orientations, for example a two-handed video game controller, there might be a preferred polarization for antennas which may dictate a ratio for the number of antennas of a given polarization. Suitable antenna types may include patch antennas with heights from about ⅛ inches to about 6 inch and widths from about ⅛ inches to about 6 inch. Patch antennas may have the advantage that polarization may depend on connectivity, i.e. depending on which side the patch is fed, the polarization may change. This may further prove advantageous as receiver 108 may dynamically modify its antenna polarization to optimize wireless power transmission.

Rectifier 306 may include diodes or resistors, inductors or capacitors to rectify the alternating current (AC) voltage generated by antenna element 304 to direct current (DC) voltage, Rectifier 306 may be placed as close as is technically possible to antenna element 304 to minimize losses. After rectifying AC voltage, DC voltage may be regulated using power converter 308. Power converter 308 can be a DC-DC converter which may help provide a constant voltage output to charge the battery 112 of cordless power tool 110. Typical voltage outputs can be from about 5 volts to about 10 volts. In some embodiments, power converter 308 may include electronic switched mode DC-DC converters which can provide high efficiency. In such a case, a capacitor (not shown) may be included before power converter 308 to ensure sufficient current is provided. Lastly, a communications component 310, similar to that of transmitter 102 from FIG. 2, may be included in receiver 108 to communicate with a transmitter or to other electronic equipment.

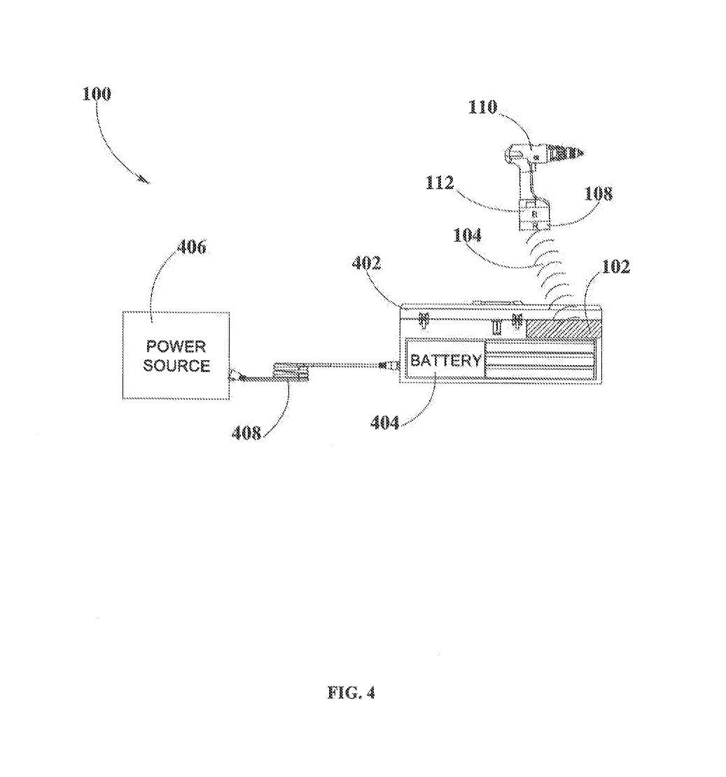

Referring now to FIG. 4, a configuration of wireless power transmission 100 may include a transmitter 102 embedded in a toolbox 402 to wirelessly charge or power one or more cordless power tools 110, according to an embodiment. Toolbox 402 may be capable of storing and transporting a plurality of cordless power tools 110 and other related tools or components. Transmitter 102 may be embedded in a region or area of toolbox 402 suitable for transmitting RF waves 104 towards receiver 108 which may be attached or operatively coupled to the battery 112 of cordless power tool 110. For example, transmitter 102 may be positioned at the top right corner of toolbox 402 housing (as shown in FIG. 4) to direct RF waves 104 towards receiver 108 for the generation of pockets of energy 106 capable of wirelessly charging the battery 112 of cordless power tool 110.

Toolbox 402 may also include a battery 404 which may be operatively coupled with transmitter 102 through a cable (not shown in FIG. 4) for allowing the generation and transmission of RF waves 104 as required by the application. Simply put, battery 404 may function as a power source 212 for transmitter 102 as shown in FIG. 2. In an embodiment, toolbox 402 may be connected to an external power source 406 to charge battery 404 through a suitable cable 408, while simultaneously powering transmitter 102 for the generation and transmission of RF waves 104 directed towards receiver 108 which can embedded or attached to cordless power tool 110. External power source 406 source may include a 120/220 AC volts outlet, in which case toolbox 402 may include a suitable AC/DC converter (not shown in FIG. 4) for converting AC voltage and supplying DC voltage to battery 404 for charging.

In another embodiment, when battery 404 is charged to a suitable level, toolbox 402 may be disconnected from external power source 406, and subsequently carried and positioned in a desired working area where cordless power tool 110 may be used. In this case, transmitter 102 may receive power for the generation and transmission of RF waves 104 solely and directly from battery 404. Charged battery 404 in toolbox 402 may provide enough charge to transmitter 102 for the generation of pockets of energy 106 within a power range of about 1 watt to about 5 watts, and within a working distance of about 5 ft. to about 20 ft. These power levels of pocket of energy 106 may be suitable for charging the battery 112 of cordless power tool 110 while in use, or at least extending the life of battery 112 during operation. In general, the power and range of the generated RF waves 104 may vary according to the number of antenna elements 204, distribution, and size of transmitter 102. A cordless power tool 110 not in use or in standby can also be charged by transmitter 102 embedded in toolbox 402,

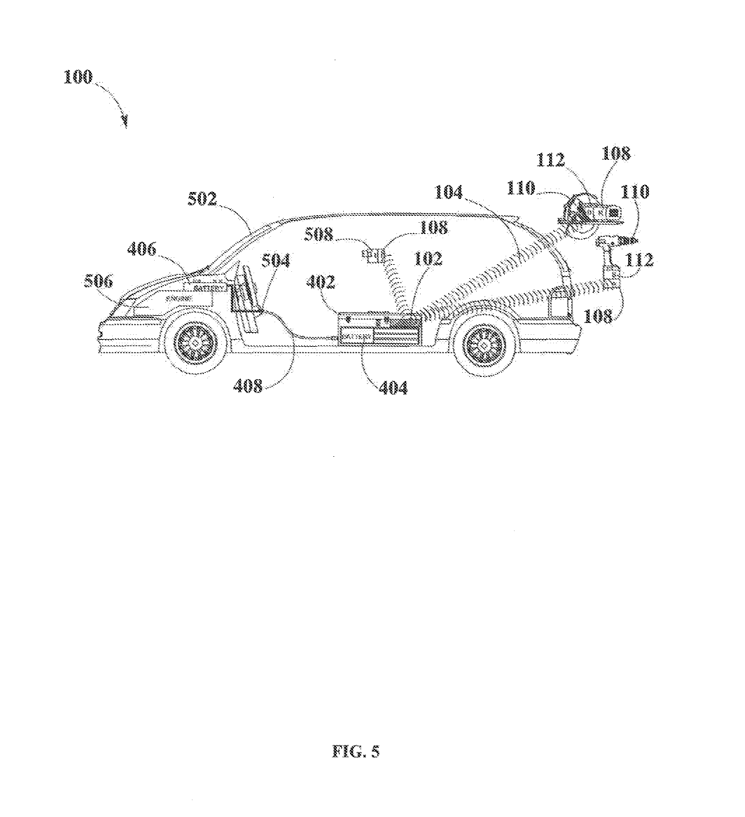

FIG. 5 shows another configuration of wireless power transmission 100 where the portable toolbox 402 may be located on or within a vehicle 502, according to an embodiment. Vehicle 502 may be a private car or a service van commonly used by technicians having to perform field work or related activities, Similarly as in FIG. 4, toolbox 402 may be connected to external power source 406 for charging battery 404 and powering transmitter 102. External power source 406, in this case, may be the battery of vehicle 502. Toolbox 402 may be operatively coupled to external power source 406 through a suitable connection that includes a car lighter socket 504 and cable 408. In order to avoid draining the battery of vehicle 502, engine 506 may be on or running when charging battery 404 or powering transmitter 102 in toolbox 402. In an embodiment, transmitter 102 may generate and direct RF waves 104 towards the receivers 108 embedded or attached to one or more cordless power tools 110 for the wireless charging of batteries 112. Transmitter 102 in toolbox 402 may wirelessly charge or power two or more cordless power tools 110 simultaneously or sequentially according to the power or application requirements. Transmitter 102 in toolbox 402 may also charge a spare battery 508 having a suitable receiver 108 attached.

In an embodiment, when battery 404 in toolbox 402 is charged to a suitable level, toolbox 402 can be disconnected from the car lighter socket 504 and placed at a location outside vehicle 502. Transmitter 102 in toolbox 402 may subsequently generate RF waves 104 which may wirelessly charge or at least extend the life of batteries 112 during the operation of cordless power tools 110. In this case, transmitter 102 may be energized directly from the charged battery 404 in toolbox 402. Surface area of the antenna array used in transmitter 102 embedded in toolbox 402 may range from approximately two in² to about 12 in² depending on the dimensions of toolbox 402.

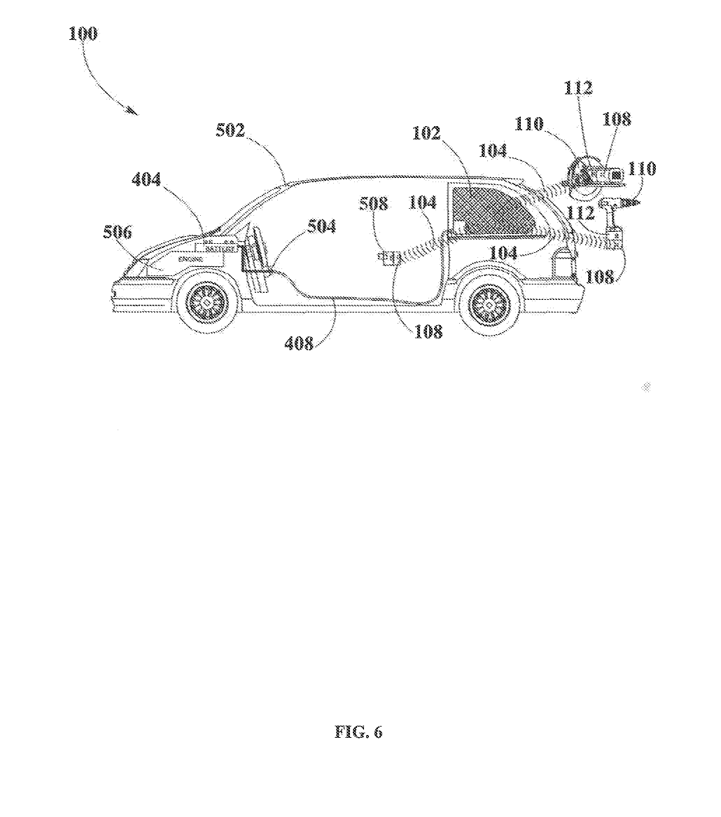

FIG. 6 illustrates a further configuration of wireless power transmission 100 where transmitter 102 may be configured in the doors or windows of vehicle 502, according to an embodiment. Specifically, the antenna array of transmitter 102 may be configured to fit one window of vehicle 502 as shown in FIG. 6; in which case, said antenna array may include between about 300 and about 600 antenna elements 204 distributed within a surface area that may vary between about 90 in² and about 160 in². This increased number of antenna elements 204 and footprint of transmitter 102 may allow for a higher level of power distribution and reach of the emitted RF waves 104 as compared to the embodiment shown in FIG. 5. For example, transmitter 102 within the specified dimensions and number of antenna elements 204 may emit RF waves 104 capable of generating pocket of energy 106 between about 1 Watts and 10 Watts of power, and within a distance of about 30 ft. and about 50 ft.

In FIG. 6, transmitter 102 may be constantly and directly connected to an external power source 406 such as vehicle 502 battery via car lighter socket 504 and cable 408. Engine 506 may be on or running when transmitter 102 is in operation in order to prevent draining the vehicle 502 battery. Transmitter 102 may generate and direct RF waves 104 towards the receivers 108 embedded or attached to one or more cordless power tools 110 for the charging of batteries 112. Transmitter 102 may wirelessly charge or power two or more cordless power tools 110 simultaneously or sequentially according to the power or application requirements. Transmitter 102 may also wirelessly charge a spare battery 508 having a suitable receiver 108 attached.

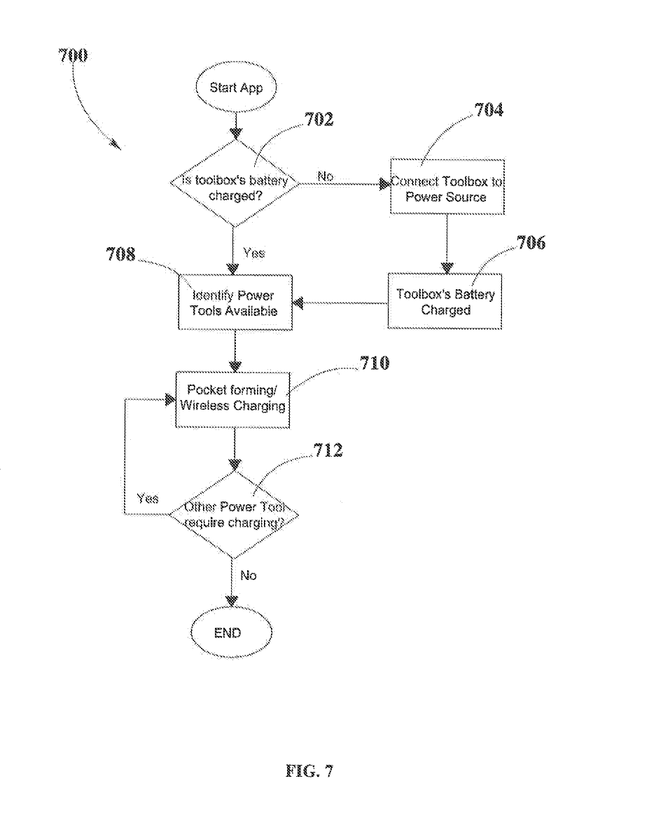

FIG. 7 shows a simplified flowchart of a wireless power transmission process 700 that may be implemented for charging one or more cordless power tools 110 using toolbox 402 as a portable device. This process may be applicable to the embodiments of wireless power transmission 100 shown in FIG. 4 and FIG. 5.

Wireless power transmission process 700 may begin by checking the charge levels of battery 404 embedded in toolbox 402, at block 702. This charge check may be performed by a control module included in toolbox 402 (not shown in FIG. 4 and FIG. 5) or by micro-controller 208 in transmitter 102, which may be operatively connected to battery 404. Different charging levels for battery 404 may be established for maintaining suitable operation. For example, minimum and maximum charging thresholds may be established at about 25% and 99% of total charge respectively. At block 704, if battery 404 charge is below the minimum threshold or 25%, then toolbox 402 can be connected to external power source 406 using cable 408, where external power source 406 may include vehicle 502 battery or a standard 120/220 AC volts outlet as explained in FIG. 4 and FIG. 5. When battery 404 charge is at 99% or at least above 25%, toolbox 402 can be disconnected from external power source 406, at block 706.

If battery 404 is charged to a suitable level, specifically between about 25% and about 99%, then wireless power transmission process 700 may continue at block 708, where communications component 210 in transmitter 102 may identify one or more cordless power tools 110 that may require wireless charging. Charging or powering priorities and other parameters such as power intensity and pocket-forming focus/timing may be established using a control module included in toolbox 402 (not shown in FIG. 4 and FIG. 5) or micro-controller 208 in transmitter 102. For example, based on charging or powering priorities, transmitter 102 may be configured to first provide wireless charging to cordless power tools 110 in use, followed by cordless power tools 110 in standby, and lastly to spare batteries 508.

After cordless power tools 110 are identified and charging priorities/parameters in transmitter 102 are set, transmission of RF waves 104 towards the designated cordless power tools 110 or spare batteries 508 can begin, at block 710, where these RF waves 104 may generate pockets of energy 10$ at receivers 108 for powering or charging one or more cordless power tools 110 and spare batteries 508 sequentially or simultaneously.

Using communications component 210, transmitter 102 in toolbox 402 may continuously check if there are other cordless power tools 110 or spare batteries 508 that may require wireless charging or powering, at block 712. If new or additional cordless power tools 110 or spare batteries 508 are identified, then transmitter 102 in toolbox 402 may wirelessly charge the identified cordless power tools 110 and spare batteries 508 according to the established charging priorities and parameters. If no further cordless power took 110 are recognized by communications component 210 in transmitter 102, then wireless power transmission process 700 may end.

While various aspects and embodiments have been disclosed, other aspects and embodiments are contemplated. The various aspects and embodiments disclosed are for purposes of illustration and are not intended to be limiting, with the true scope and spirit being indicated by the following claims.

Having thus described the invention, we claim:

1. A method for wireless transmission of power to a cordless power tool, comprising:
connecting a pocket-forming transmitter to a power source;
generating RF waves from a RF circuit embedded within the transmitter;
generating communication signals from a communication circuit embedded with the transmitter;
controlling the generated RF waves and the communication signals with a digital signal processor in the transmitter;
transmitting the power RF waves and communication signals through an antenna connected to the transmitter; and
capturing the RF waves forming pockets of energy in 3-D space at a receiver with an antenna connected to the cordless power tool to convert the power RF waves into a DC voltage for charging or powering a battery of the cordless tool,

2. The method for wireless transmission of power to a cordless power tool of claim 1, wherein the receiver includes a communication circuit to communicate power and receiver location information via communication signals between the transmitter and receiver.

3. A method for wireless transmission of power to a cordless power tool, comprising:
connecting a pocket-forming transmitter to a power source;
generating pocket forming RF waves from a RF circuit embedded within the transmitter;
generating communication signals from a communication circuit embedded within the transmitter;
controlling the generated RF waves and the communication signals with a digital signal processor;
transmitting the RF waves and communication signals through at least two antennas electrically connected to the RF and communication circuits within the transmitter; and
capturing pockets of energy produced by the pocket-forming RE waves converging in 3-D space at a receiver with an antenna connected to a battery of the cordless power tool wherein the pockets of energy are converted into a DC voltage for charging the battery or powering the cordless power tool and wherein communication signals are generated at the receiver to provide location and power requirements of the cordless tool to the transmitter.

4. The method for wireless transmission of power to a cordless power tool, comprising the steps of:
emitting RF waves from a pocket-forming transmitter to generate multiple pockets of energy in 3-D space through pocket-forming;
coupling receivers to the battery of multiple cordless tools;
capturing the multiple pockets of energy in 3-D space at the receivers; and
powering or charging the battery of multiple cordless tools from the pockets of energy.

5. The method for wireless transmission of power to a cordless power tool of claim 1, wherein the pocket-forming transmitter is located in a portable toolbox having a fully charged battery connected to the transmitter as a power source.

6. The method for wireless transmission of power to a cordless power tool of claim 1, wherein the pocket-forming transmitter in the portable toolbox is located in a vehicle wherein the toolbox battery is connected to the vehicle battery as a source to charge the toolbox battery.

7. The method for wireless transmission of power to a cordless power tool of claim 5, wherein the toolbox transmitter is used to charge the cordless power tool and an extra cordless tool battery connected to a battery charger having a receiver to convert the pockets of energy into the DC charging voltage for the extra battery.

8. The method for wireless transmission of power to a cordless power tool of claim 1, wherein the pocket-forming transmitter is mounted within a vehicle and the power source is a vehicle battery used by the transmitter to wirelessly charge the cordless power tool located in a predetermined distance from the vehicle and to wirelessly charge an extra battery in a battery charger mounted in the vehicle having a receiver attached or connected to the battery charger for receiving the pockets of energy.

9. The method for wireless transmission of power to a cordless power tool of claim 1, wherein the receiver is embedded or attached to the cordless power tool or a battery charger.

10. The method for wireless transmission of power to a cordless power tool of claim 1, wherein the antennas in the transmitter and receiver operate in the frequency bands of 900 MHz, 2.5 GHz or 5.8 GHz.

11. The method for wireless transmission of power to a cordless power tool of claim 1, further includes the step of generating multiple pockets of energy from the pocket forming transmitter to power or charge multiple cordless power tools within a predetermined distance from the transmitter.

12. The method for wireless transmission of power to a cordless power tool of claim 1, wherein the digital signal processor is a microprocessor or microcontroller controlling the RF and communication circuits.

13. The method for wireless transmission of power to a cordless power tool of claim 1, further comprising the step of communicating between the receiver and the transmitter through the communication signals or pilot signals on conventional wireless communication protocols including Bluetooth, Wi-Fi, Zigbee or FM radio signals.

14. The method for wireless transmission of power to a cordless power tool of claim 1, wherein the communication signals sent by the receiver provide optimum times and locations for transmitter pocket-forming and the convergence of pockets of energy in 3-D space to predetermined cordless power tools or an extra battery charger within predetermined distances from the transmitter.

15. A wireless transmission of power to a cordless power tool, comprising:
a pocket-forming transmitter for emitting power RF waves to form pockets of energy to converge in 3-d space connected to a power source; and
a receiver embedded or attached to the cordless power tool for receiving and converting the pockets of energy to a DC voltage for charging or powering a cordless power tool battery connected to the cordless tool.

16. The wireless transmission of power to a cordless power tool of claim 14, wherein the pocket-forming transmitter is located in close proximity to a work project where the cordless power tool is used to charge or power the cordless power tool battery during the operation of the cordless power tool.

17. The wireless transmission of power to a cordless power tool of claim 14, wherein the pocket-forming transmitter is located in a toolbox and connected to an electrical outlet or to a storage battery located in the toolbox.

18. The wireless transmission of power to a cordless power tool of claim 14, wherein the receiver is embedded or attached to the cordless power tool and connected to the cordless power tool battery.

19. The wireless transmission of power to a cordless power tool of claim 14, wherein the transmitter is mounted within a vehicle and connected to a vehicle battery for the power source or the transmitter within the vehicle is located in a toolbox having a toolbox battery for the power source connected to the vehicle battery as a further backup power source for the toolbox battery.

20. An apparatus for wireless power transmission to a cordless power tool, comprising:
a battery connected to the cordless power tool;
a portable pocket-forming transmitter having at least two or more antenna elements, at least one RF integrated circuit, at least one digital signal processor or micro-controller, one communication circuit to generate pockets of energy consisting of constructive patterns of power RF waves in 3-D space; and
a receiver embedded or attached to the cordless power tool having at least one antenna element, at least one rectifier, at least one power converter and a communication circuit for communicating with the transmitter the exact location and power requirements of the cordless power tool for receiving the pockets of energy in 3-D space to charge or power the cordless power tool.

21. The apparatus for wireless power transmission to a cordless power tool of claim 19, wherein the communication circuitry of the transmitter and receiver utilizes Bluetooth, infrared, Wi-Fi, FM radio or Zigbee for the communication protocols between the receiver and the transmitter.

22. The apparatus for wireless power transmission to a cordless power tool of claim 19, wherein the transmitter further includes flat antenna elements, patch antenna elements or dipole antenna elements with heights from approximately 1/24 inches to about 1 inch and widths from approximately 1/24 inches to about 1 inch.

23. The apparatus for wireless power transmission to a cordless power tool of claim 19, wherein the antenna elements of the transmitter operate in frequency bands of 900 MHz, 2.5 GHz or 5.8 GHz.

24. The apparatus for wireless power transmission to a cordless power tool of claim 19, wherein the antenna elements of the transmitter operate in independent frequencies that allow a multichannel operation of pocket-forming in a single array, pair array, quad array or other suitable arrangement for powering the cordless power tool or a portable battery charger located in a toolbox or a vehicle with the transmitter located in close proximity thereto,

25. The apparatus for wireless power transmission to a cordless power tool of claim 19, wherein the antenna elements of the transmitter include polarization of vertical pole, horizontal, circularly polarized, left hand polarized, right hand polarized or a combination of polarizations to maximize the transmission of pockets of energy to predetermined cordless power tools or battery chargers in close proximity to the transmitter.
